(19) United States
(12) Patent Application Publication
(10) Pub. No.: US 2023/0031453 A1
(43) Pub. Date: Feb. 2, 2023

(54) DRILL AND METHOD FOR MANUFACTURING MACHINED PRODUCT

(71) Applicant: KYOCERA CORPORATION, Kyoto-shi, Kyoto (JP)

(72) Inventor: Masahiko KURODA, Higashiomi-shi, Shiga (JP)

(21) Appl. No.: 17/784,106

(22) PCT Filed: Dec. 10, 2020
(86) PCT No.: PCT/JP2020/046081

§ 371 Date: Jun. 10, 2022

(30) Foreign Application Priority Data
Dec. 11, 2019 (JP) 2019-223406

(51) Int. Cl. B23B 51/02

(52) U.S. Cl. CPC B23B 51/02; B23B 2251/082; B23B 2251/14

(57) ABSTRACT

A drill may include a body which is extended along a rotation axis from a first end to a second end. The body may include a first cutting edge, a second cutting edge, a thinning surface, a flute, and an outer peripheral surface. The outer peripheral surface may include a first margin surface, a clearance surface, and a second margin surface. In a plan view of the first end, an imaginary straight line connecting the rotation axis and an end part on a side of an outer periphery in the first cutting edge may be a first straight line, and an imaginary straight line which passes through a center of the first straight line and is orthogonal to the first straight line may be a second straight line. The second straight line may intersect with the second margin surface.

### CROSS-REFERENCE TO RELATED APPLICATION

This application is a national stage entry according to 35 U.S.C. 371 of PCT Application No. PCT/JP2020/046081 filed on Dec. 10, 2020, which claims priority to Japanese Patent Application No. 2019-223406, filed Dec. 11, 2019. The contents of this application are incorporated herein by reference in their entirety.

### TECHNICAL FIELD

The present disclosure may generally relate to a drill used in a drilling process of a workpiece, and a method for manufacturing a machined product. Examples of the drill may include solid drills and indexable drills.

### BACKGROUND

For example, a drill is discussed in Japanese Unexamined Patent Publication No. 2011-020256 (Patent Document 1) as a drill used for a drilling process of a workpiece, such as metal. The drill discussed in Patent Document 1 may include first to third margin parts on an outer peripheral surface. If the drill thus includes a plurality of margin surfaces, the drill had enhanced straight running stability.

In recent years, there has been a demand for a drill having higher straight running stability.

### SUMMARY

A drill in a non-limiting aspect of the present disclosure may include a body which is extended along a rotation axis from a first end to a second end and is rotatable around the rotation axis. The body may include a first cutting edge, a second cutting edge, a thinning surface, a flute and an outer peripheral surface. The first cutting edge may be located on a side of the first end and may be extended from the rotation axis toward an outer periphery. The second cutting edge may be extended from the first cutting edge toward an outer periphery. The thinning surface may be located along the first cutting edge. The flute may be extended spirally around the rotation axis from the second cutting edge and the thinning surface toward the second end. The outer peripheral surface may include a first margin surface, a clearance surface and a second margin surface. The first margin surface may be located along the flute on a rear side in a rotation direction of the rotation axis. The clearance surface may be located along the first margin surface on a rear side in the rotation direction. The second margin surface may be located along the clearance surface on a rear side in the rotation direction. In the plan view of the first end, an imaginary straight line connecting the rotation axis and an end part of the first cutting edge which is located on a side of an outer periphery may be a first straight line, and an imaginary straight line which passes through a center of the first straight line and is orthogonal to the first straight line may be a second straight line. The second straight line may intersect with the second margin surface.

### BRIEF DESCRIPTION OF THE DRAWINGS

FIG. 1 is a perspective view illustrating a drill in a non-limiting embodiment of the present disclosure;

FIG. 2 is a plan view of the drill illustrated in FIG. 1 as viewed toward a first end;

FIG. 3 is a plan view of the drill illustrated in FIG. 1 as viewed toward the first end;

FIG. 4 is a side view of the drill illustrated in FIG. 2 as viewed from a B1 direction;

FIG. 5 is a side view of the drill illustrated in FIG. 2 as viewed from a B2 direction;

FIG. 6 is a side view of the drill illustrated in FIG. 2 as viewed from a B3 direction;

FIG. 7 is an enlarged view of a region A1 illustrated in FIG. 1;

FIG. 8 is a sectional view taken along the line VIII-VIII in the drill illustrated in FIG. 6;

FIG. 9 is a plan view of a drill in a non-limiting embodiment of the present disclosure as viewed toward a first end, which corresponds to FIG. 3;

FIG. 10 is a schematic diagram illustrating one of steps in a method for manufacturing a machined product in a non-limiting embodiment of the present disclosure;

FIG. 11 is a schematic diagram illustrating one of the steps in the method for manufacturing a machined product in the non-limiting embodiment of the present disclosure; and

FIG. 12 is a schematic diagram illustrating one of the steps in the method for manufacturing a machined product in the non-limiting embodiment of the present disclosure.

### EMBODIMENTS

<Drills>

Drills in a plurality of non-limiting embodiments of the present disclosure may be individually described in detail below with reference to the drawings. For convenience of description, the drawings referred to in the following may illustrate, in simplified form, only main members necessary for describing the embodiments. The drills may therefore include any arbitrary structural member not illustrated in the drawings referred to. Dimensions of the members in each of the drawings may faithfully represent neither dimensions of actual structural members nor dimensional ratios of these members.

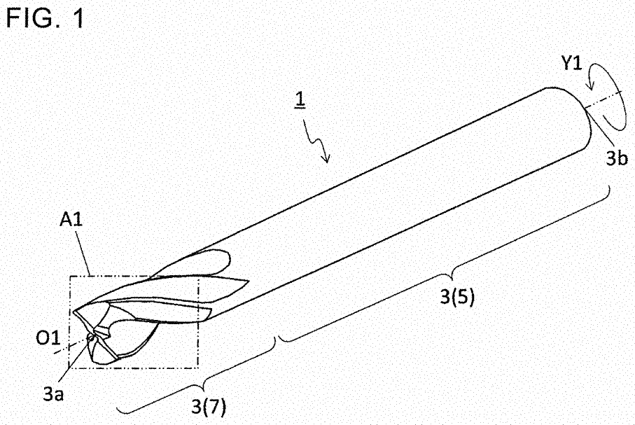

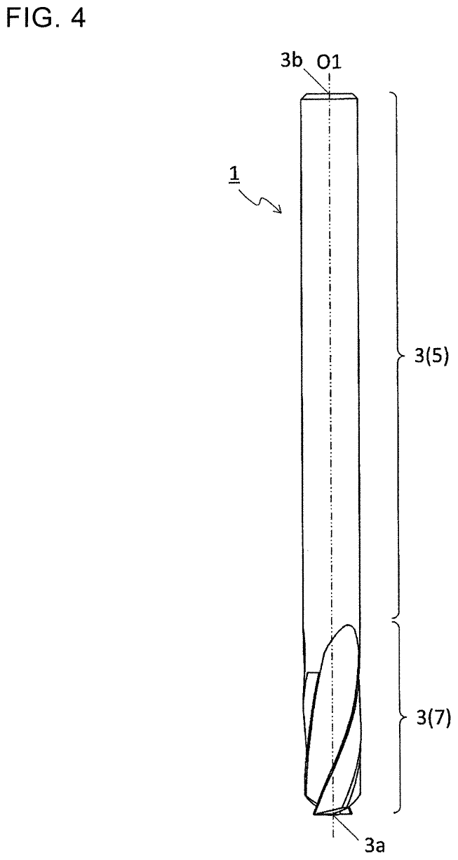

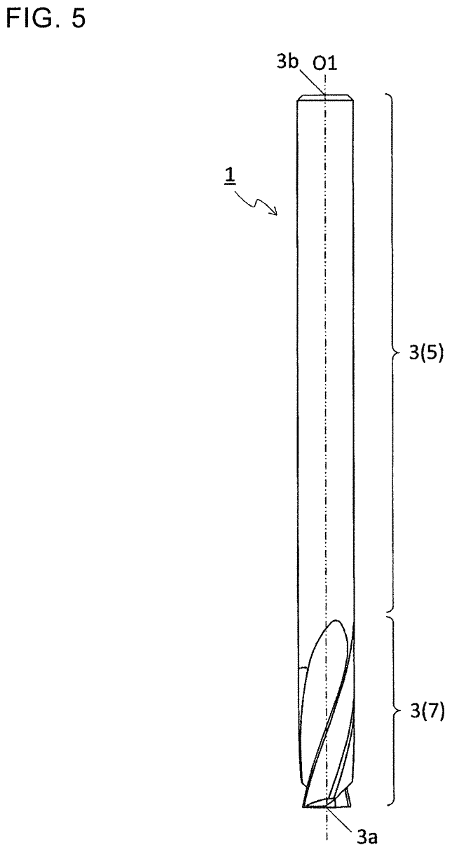

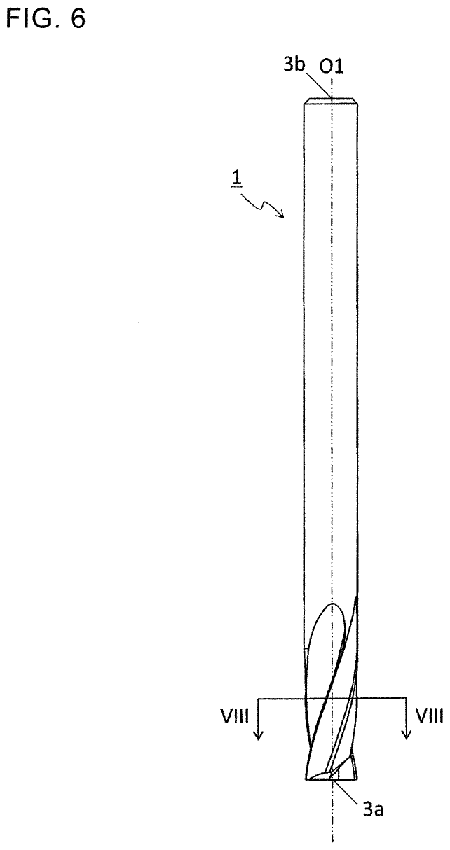

FIGS. 1 to 8 may illustrate a solid drill as a non-limiting embodiment of the drill 1. The drill 1 is not limited to the solid drill, but may be, for example, an indexable drill.

The drill 1 may include a body 3 as in the non-limiting embodiment illustrated in FIG. 1. The body 3 may be extended along a rotation axis O1 from a first end 3a to a second end 3b. More specifically, the body 3 may have a bar shape extended along the rotation axis O1 from the first end 3a to the second end 3b. In general, the first end 3a may be called “a front end,” and the second end 3b may be called “a rear end.” The body 3 may be rotatable around the rotation axis O1. An arrow Y1 in FIG. 1 and the like may indicate a rotation direction of the rotation axis O1.

The body 3 may include a shank part 5 and a cutting part 7. The shank part 5 may be a part that can be held by a spindle to be rotated in a machine tool. The shank part 5 may be designed according to a shape of the spindle in the machine tool.

The cutting part 7 may be located on a side of the first end 3a relative to the shank part 5. The cutting part 7 may be a part which is contactable with a workpiece and is capable of playing a main role in a cutting process (for example, a drilling process) of the workpiece.

An outer diameter D of the cutting part 7 is not limited to a specific value. For example, a maximum value of the outer diameter D may be set to 4-50 mm. A length L of the cutting part 7 in a direction along the rotation axis O1 may be set to L=1.5 D to L=12 D.

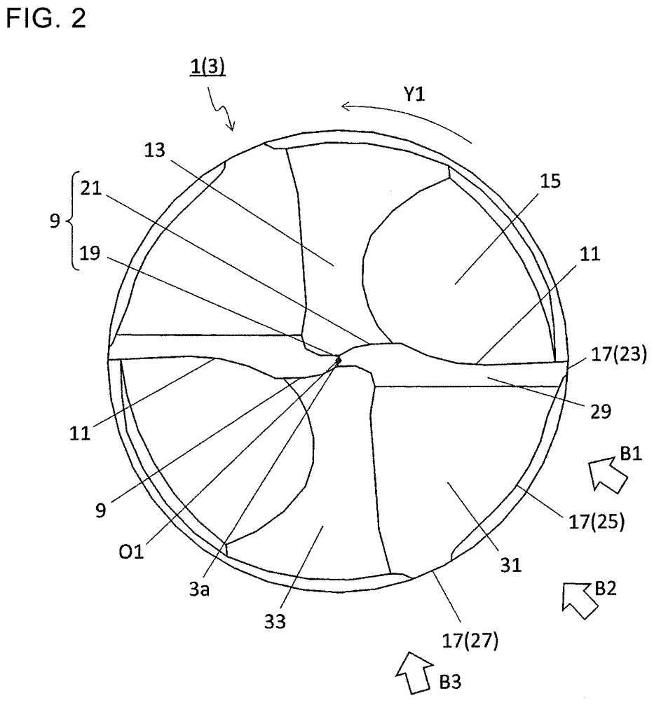

The body 3 may include a first cutting edge 9, a second cutting edge 11, a thinning surface 13, a flute 15 and an outer peripheral surface 17 as in the non-limiting embodiment illustrated in FIG. 2. The first cutting edge 9 may be located on a side of the first end 3a. The first cutting edge 9 may be extended from the rotation axis O1 toward an outer periphery. The second cutting edge 11 may be extended from the first cutting edge 9 toward the outer periphery. The thinning surface 13 may be located along the first cutting edge 9. The flute 15 may be extended spirally around the rotation axis O1 from the second cutting edge 11 and the thinning surface 13 toward the second end 3b. The first cutting edge 9, the second cutting edge 11, the thinning surface 13, the flute 15 and the outer peripheral surface 17 may be located on the cutting part 7.

The first cutting edge 9 may be usable for cutting out a workpiece in a cutting process. The number of the first cutting edge 9 may be one or a plural number. If the number of the first cutting edges 9 is the plural number, the number thereof may be 2 to 5. These points may also be true for the second cutting edge 11. The drill 1 in the non-limiting embodiment illustrated in FIG. 1 may be a so-called 2-cutting edge drill.

In cases where the number of the first cutting edges 9 is the plural number, the first cutting edges 9 may be located so as to have rotational symmetry relative to the rotation axis O1 if viewed toward the first end 3a. Specifically, if the number of the first cutting edges 9 is two as in the non-limiting embodiment illustrated in FIG. 2, the two first cutting edges 9 may be located so as to have 180-degree rotational symmetry relative to the rotation axis O1 if viewed toward the first end 3a. This may lead to enhanced straight running stability of the drill 1 when cutting out the workpiece. These points may also be true for the second cutting edge 11.

The first cutting edge 9 may include a chisel edge 19. The chisel edge 19 may be located closest to the rotation axis O1 in the first cutting edge 9. The chisel edge 19 may be located so as to intersect with the rotation axis O1. The chisel edge 19 may have a straight line shape or curvilinear shape if viewed toward the first end 3a. The chisel edge 19 in the non-limiting embodiment illustrated in FIG. 2 may have the straight line shape if viewed toward the first end 3a.

The first cutting edge 9 may include a thinning edge 21. The shinning edge 21 may be located closer to the outer peripheral surface 17 than the chisel edge 19. The shinning edge 21 may have a larger length than the chisel edge 19. The chisel edge 19 and the thinning edge 21 may connect to each other, or alternatively other cutting edge may be located therebetween. The chisel edge 19 and the thinning edge 21 may connect to each other in the non-limiting embodiment illustrated in FIG. 2.

The thinning edge 21 may have a straight line shape or curvilinear shape if viewed toward the first end 3a. The thinning edge 21 may have a shape with a combination of a straight line shape and a curvilinear shape if viewed toward the first end 3a as in the non-limiting embodiment illustrated in FIG. 2.

The second cutting edge 11 may be usable for cutting out the workpiece in the cutting process. The second cutting edge 11 may also be called a main cutting edge. The second cutting edge 11 may have a larger length than the first cutting edge 9. The second cutting edge 11 may have a straight line shape or curvilinear shape if viewed toward the first end 3a. The second cutting edge 11 may have a concave curvilinear shape if viewed toward the first end 3a as in the non-limiting embodiment illustrated in FIG. 2.

The first cutting edge 9 and the second cutting edge 11 may connect to each other, or alternatively another cutting edge may be located therebetween. The first cutting edge 9 and the second cutting edge 11 may connect to each other in the non-limiting embodiment illustrated in FIG. 2.

The thinning surface 13 may be servable as a surface where chips generated by the first cutting edge 9 pass through. The thinning surface 13 may also be usable for enhancing cutting edge strength so as to enhance biting performance against a workpiece.

The flute 15 may be usable for discharging chips mainly generated by the second cutting edge 11 to the outside. The number of the flutes 15 may be at least one or may be a plural number. The number of the flutes 15 may be equal to the number of the second cutting edges 11.

The flute 15 may directly connect to the second cutting edge 11. This may lead to enhanced biting performance against the workpiece. A rake surface to connect the flute 15 and the second cutting edge 11 may be located therebetween. This may lead to a stable discharge direction of the chips generated by the second cutting edge 11. From the viewpoint of smoothly discharging the chips to the outside, the flute 15 may have a concave curvilinear shape in a cross section orthogonal to the rotation axis O1.

A depth of the flute 15 is not limited to a specific value. For example, the depth of the flute 15 may be set to 10-40% of an outer diameter of the body 3 (the cutting part 7). The depth of the flute 15 may be a value obtained by subtracting a distance between a bottom of the flute 15 and the rotation axis O1 from a radius of the body 3 (the cutting part 7) in the cross section orthogonal to the rotation axis O1. As used herein, the term “bottom” may be a part of the flute 15 which is closest to the rotation axis O1.

The outer peripheral surface 17 may include a first margin surface 23, a clearance surface 25 and a second margin surface 27. The first margin surface 23 may be located along the flute 15 on a rear side of the rotation direction Y1 of the rotation axis O1. The clearance surface 25 may be located along the first margin surface 23 on a rear side of the rotation direction Y1. The second margin surface 27 may be located along the clearance surface 25 on a rear side of the rotation direction Y1.

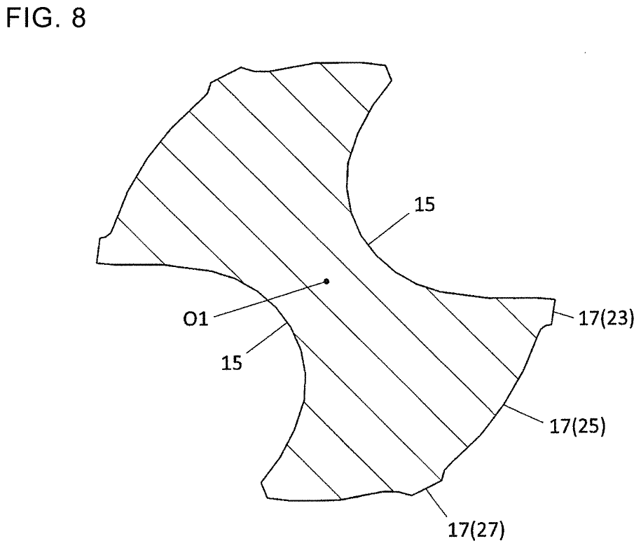

The first margin surface 23 and the second margin surface 27 may be usable for stabilizing operability of the drill 1 by being brought into sliding contact with an inner wall surface of a hole formed by the first cutting edge 9 and the second cutting edge 11. The first margin surface 23 and the second margin surface 27 may be a circular arc-shaped part corresponding to the outer periphery of the body 3 in the cross section orthogonal to the rotation axis O1 as in the non-limiting embodiment illustrated in FIG. 8.

The clearance surface 25 may be usable for reducing friction against a workpiece in a cutting process. The clearance surface 25 may be recessed relative to the first margin surface 23 and the second margin surface 27.

The first margin surface 23, the clearance surface 25 and the second margin surface 27 may connect to each other, or alternatively another surface may be located between the surfaces adjacent to each other. The first margin surface 23, the clearance surface 25 and the second margin surface 27 connect to each other in the non-limiting embodiment illustrated in FIG. 2.

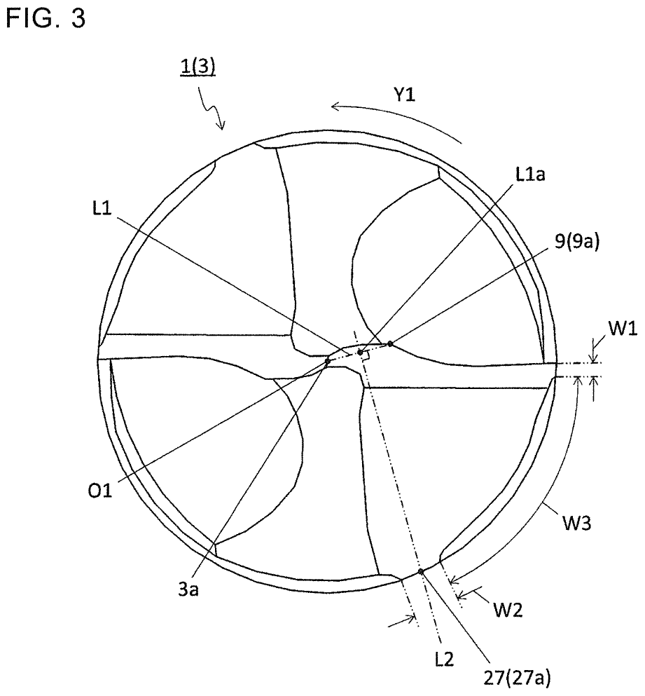

The drill 1 may have the following configuration if viewed toward the first end 3a. An imaginary straight line connecting the rotation axis O1 and an end part 9a on a side of an outer periphery in the first cutting edge 9 may be a first straight line L1 as in the non-limiting embodiment illustrated in FIG. 3. An imaginary straight line which passes through a center (midpoint) L1a of the first straight line L1 and is orthogonal to the first straight line L1 may be a second straight line L2. The second straight line L2 may intersect with the second margin surface 27. As used herein, orthogonality may denote that both are approximately orthogonal to each other, and both need not be strictly orthogonal to each other. The orthogonality may include a range of 90±2 degrees.

In the above embodiment, the first margin surface 23 and the second margin surface 27 may come into contact with a machined wall surface, and therefore, the first margin surface 23 and the second margin surface 27 may tend to serve as a guide in the drilling process. This may lead to enhanced straight running stability of the drill 1.

A width W1 of the first margin surface 23 in the rotation direction Y1 may be equal to or different from a width W2 of the second margin surface 27 in the rotation direction Y1. Compared to the first margin surface 23, the second margin surface 27 may further tend to be located in a direction of application of cutting force of cutting load applied to the second cutting edge 11 in the vicinity of the second cutting edge 11. Hence, as in the non-limiting embodiment illustrated in FIG. 3, if the width W2 is larger than the width W1, the cutting load applied to the second cutting edge 11 may tend to be stably received by the second margin surface 27.

A width W3 of the clearance surface 25 in the rotation direction Y1 may be equal to or different from each of the width W1 and the width W2. If the width W3 is larger than each of the width W1 and the width W2 as in the non-limiting embodiment illustrated in FIG. 3, it may be easy to reduce cutting resistance because of a small contact area of each of the first margin surface 23 and the second margin surface 27 with respect to a wall surface of a drilled hole.

The width W1, the width W2 and the width W3 are not limited to a specific value. For example, the width W1 may be set to 0.15-4% of a full length of the outer periphery of the body 3 (the cutting part 7) in the cross section orthogonal to the rotation axis O1. The width W2 may be set to 14-23%. The width W3 may be set to 0.3-12%.

As in the non-limiting embodiment illustrated in FIG. 3, the second straight line L2 may pass through a center (midpoint) 27a of the second margin surface 27 if viewed toward the first end 3a. In this embodiment, cutting load applied to the first cutting edge 9 may tend to be stably received by the second margin surface 27. The drill 1 may therefore be less prone to cause vibration due to the first cutting edge 9 that bites against a workpiece.

As in the non-limiting embodiment illustrated in FIG. 2, the body 3 may further include a second flank surface 29, a third flank surface 31 and a fourth flank surface 33. The second flank surface 29 may be located along the second cutting edge 11. The second flank surface 29 may be flat. The third flank surface 31 may be located along the second flank surface 29 on a rear side in the rotation direction Y1, and may be inclined relative to the second flank surface 29. The third flank surface 31 may be flat. The fourth flank surface 33 may be located along the third flank surface 31 on a rear side in the rotation direction Y1, and may be inclined relative to the third flank surface 31. The fourth flank surface 33 may be flat.

The second margin surface 27 may connect to the third flank surface 31 and may be located away from the second flank surface 29 and the fourth flank surface 33. If the second margin surface 27 is located away from the second flank surface 29, cutting force of cutting load applied to the first cutting edge 9 and the second cutting edge 11 may tend to be received by the second margin surface 27. If the second margin surface 27 is located away from the fourth flank surface 33, the second margin surface 27 may be locatable near the first end 3a than cases where the second margin surface 27 connects to the third flank surface 31. Consequently, the second margin surface 27 may be contactable with a workpiece in the vicinity of the first end 3a during the drilling process, and straight running stability of the drill 1 may tend to be improved.

Inclination angles of the third flank surface 31 and the fourth flank surface 33 are not limited to a specific value. For example, the inclination angle of the third flank surface 31 may be set to 15-35°. The inclination angle of the fourth flank surface 33 may be set to 30-55°.

The second flank surface 29, the third flank surface 31 and the fourth flank surface 33 may connect to each other, or alternatively, another surface may be located between the flank surfaces adjacent to each other. The second flank surface 29, the third flank surface 31 and the fourth flank surface 33 may connect to each other in the non-limiting embodiment illustrated in FIG. 2.

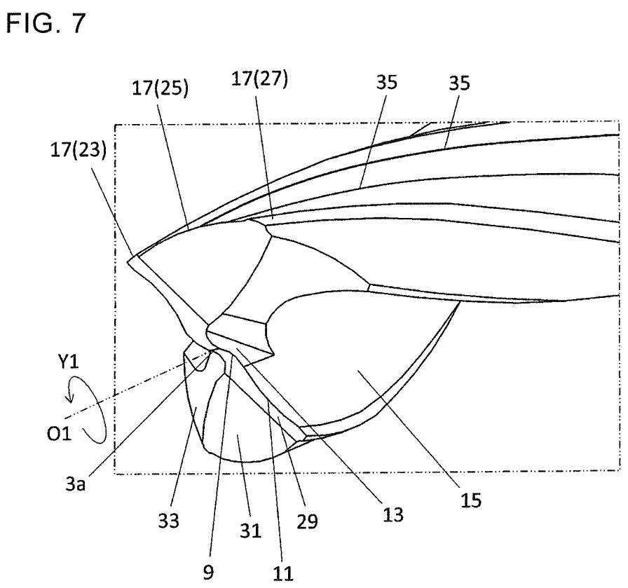

The clearance surface 25 may include a plurality of ridge parts (convex parts) 35 extended along the first margin surface 23 as in the non-limiting embodiment illustrated in FIG. 7. In this embodiment, the clearance surface 25 may have a large surface area and may tend to have high heat dissipation. Therefore, heat generated during a cutting process may tend to escape to the outside, and it may be easy to avoid that the drill 1 has excessively high temperature.

The width W2 of the second margin surface 27 in the rotation direction Y1 may be equal to or different from the length of the first cutting edge 9 if viewed toward the first end 3a. If the width W2 is equal to the length of the first cutting edge 9, cutting load generated by the first cutting edge 9 may tend to be stably received by the second margin surface 27. Consequently, vibration of the drill 1 may be less likely to occur. The phrase that the width W2 is equal to the length of the first cutting edge 9 is not limited to the fact that both are strictly equal to each other. For example, there may be a difference of approximately 10% between both values.

For example, cemented carbide and cermet may be usable as a material of the body 3. Examples of composition of the cemented carbide may include WC—Co, WC—TiC—Co and WC—TiC—TaC—Co, in which WC, TiC and TaC may be hard particles, and Co may be a binding phase.

The cermet may be a sintered composite material obtainable by compositing metal into a ceramic component. Examples of the cermet may include titanium compounds composed mainly of titanium carbide (TiC) or titanium nitride (TiN). The above materials may be shown by way of illustration, and the material of the body 3 is not limited thereto.

A surface of the body 3 may be coated with a coating film by using chemical vapor deposition (CVD) method or physical vapor deposition (PVD) method. Examples of composition of the coating film may include titanium carbide (TiC), titanium nitride (TiN), titanium carbonitride (TiCN) and alumina (Al₂O₃).

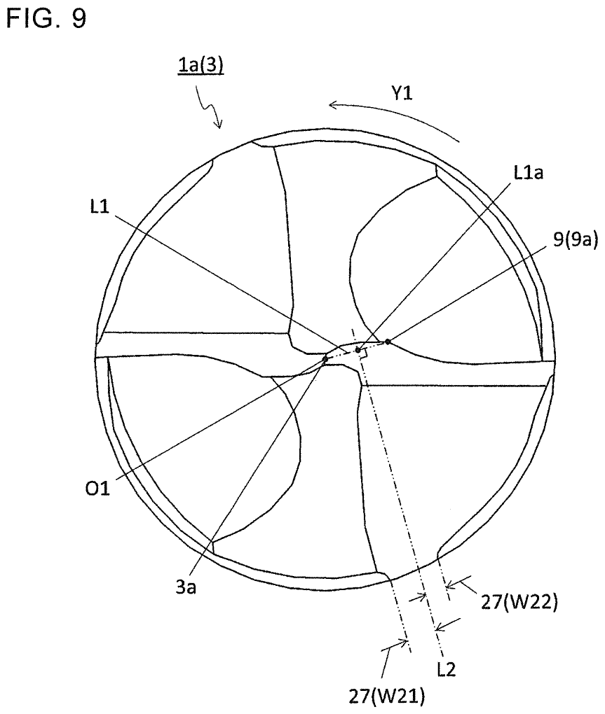

A drill 1a in a non-limiting embodiment may be described below with reference to FIG. 9. The following mainly may make it clear where the drill 1a is different from the drill 1. Detailed description of configurations similar to those of the drill 1 may be omitted in some cases.

As in a non-limiting embodiment illustrated in FIG. 9, in the drill 1a, a width W21 of a part of the second margin surface 27 which is located on a more rear side in the rotation direction Y1 than the second straight line L2 may be larger than a width W22 of a part of the second margin surface 27 which is located on a more front side in the rotation direction Y1 than the second straight line L2 if viewed toward the first end 3a. In this embodiment, if the drill 1a is viewed toward the first end 3a, it may be easy to ensure a part of the second margin surface 27 which forms a small angle with the second cutting edge 11. Hence, not only cutting load applied to the first cutting edge 9 but also cutting load applied to the second cutting edge 11 may tend to be stably received by the second margin surface 27. This may make it easier to improve straight running stability during machining.

<Method for Manufacturing Machined Product>

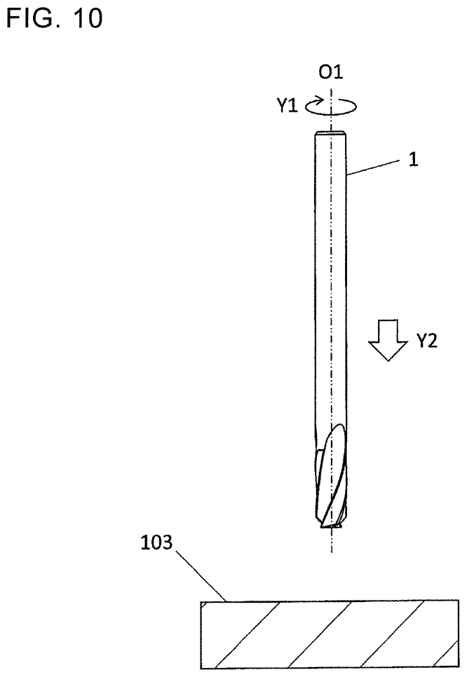

A method for manufacturing a machined product 101 in a non-limiting embodiment may be described in detail below with reference to FIGS. 10 to 12. Although the drill 1 is used in the non-limiting embodiment illustrated in FIGS. 10 to 12, there is no intention to limit to this embodiment. For example, the drill 1a may be used.

The machined product 101 may be manufactured by carrying out a cutting process of a workpiece 103. The method for manufacturing the machined product 101 may include the following steps (1) to (4).

(1) Putting the drill 1 above the prepared workpiece 103 (refer to FIG. 10).

(2) Rotating the drill 1 around the rotation axis O1 in a direction of an arrow Y1, and bringing the drill 1 near the workpiece 103 in a Y2 direction (refer to FIG. 10).

The above steps (1) and (2) may be carried out by, for example, fixing the workpiece 103 onto a table of a machine tool with the drill 1 attached thereto, and by bringing the drill 1 being rotated near the workpiece 103. In the step (2), the workpiece 103 and the drill 1 may be brought close to each other. For example, the workpiece 103 may be brought near the drill 1.

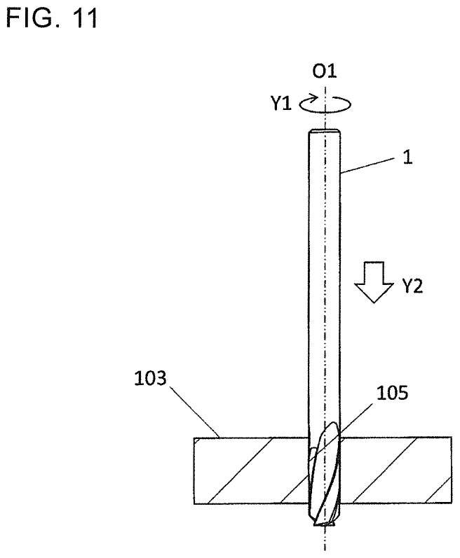

(3) Forming a drilled hole 105 in the workpiece 103 by bringing the drill 1 further near the workpiece 103 so that the drill 1 being rotated comes into contact with a desired position on a surface of the workpiece 103 (refer to FIG. 11).

In the step (3), the cutting process may be carried out so that at least a part of the cutting part 7 in the body 3 is located in the drilled hole 105.

Alternatively, setting may be made so that the shank part 5 in the body 3 is located outside the drilled hole 105. From the viewpoint of obtaining a good finished surface, setting may be made so that a part of the cutting part 7 which is located on a side of the second end 3b is located outside the drilled hole 105. The above part may be servable as a margin region for discharging chips, thereby offering excellent chip discharge performance through the region.

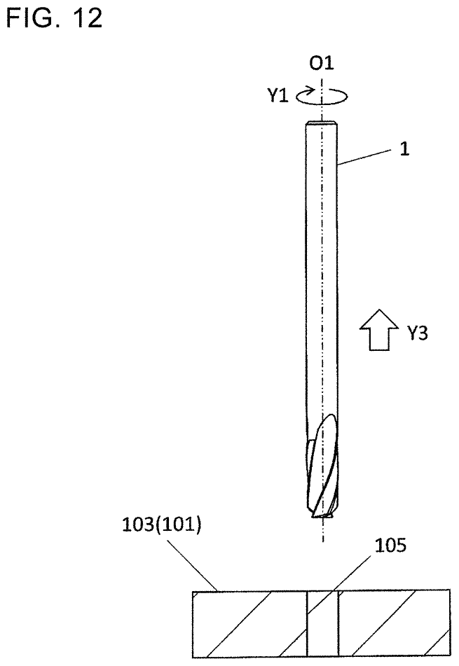

(4) Moving the drill 1 away from the workpiece 103 in a Y3 direction (refer to FIG. 12).

Also, in the step (4), similarly to the step (2), the workpiece 103 and the drill 1 may be separated from each other. For example, the workpiece 103 may be moved away from the drill 1.

Excellent machinability can be offered by carrying out the above steps. Specifically, if using the drill 1 in the method for manufacturing the machined product 101 in the non-limiting embodiment, the machined product 101 having the highly accurate drilled hole 105 may be obtainable because the drill 1 has high straight running stability.

In cases where the cutting process of the workpiece 103 as described above is carried out a plurality of times and, for example, a plurality of drilled holes 105 may be formed in the single workpiece 103, the step of bringing the first cutting edge 9 and the second cutting edge 11 of the drill 1 into contact with different portions of the workpiece 103 may be repeated while keeping the drill 1 rotated.

Examples of material of the workpiece 103 may include aluminum, carbon steel, alloy steel, stainless steel, cast iron and nonferrous metals.

1. A drill, comprising:
a body which is extended along a rotation axis from a first end to a second end and is rotatable around the rotation axis,
the body comprising
a first cutting edge located on a side of the first end and extended from the rotation axis toward an outer periphery,
a second cutting edge extended from the first cutting edge toward an outer periphery,
a thinning surface located along the first cutting edge,
a flute extended spirally around the rotation axis from the second cutting edge and the thinning surface toward the second end, and
an outer peripheral surface, wherein
the outer peripheral surface comprising
a first margin surface located along the flute on a rear side in a rotation direction of the rotation axis,
a clearance surface located along the first margin surface on a rear side in the rotation direction, and
a second margin surface located along the clearance surface on a rear side in the rotation direction,
in a plan view of the first end,
an imaginary straight line connecting the rotation axis and an end part on a side of an outer periphery in the first cutting edge is a first straight line,
an imaginary straight line which passes through a center of the first straight line and is orthogonal to the first straight line is a second straight line, and
the second straight line intersects with the second margin surface.

2. The drill according to claim 1, wherein a width of the second margin surface in the rotation direction is larger than a width of the first margin surface in the rotation direction.

3. The drill according to claim 1, wherein the second straight line passes through a center of the second margin surface in the plan view of the first end.

4. The drill according to claim 1, wherein, in the plan view of the first end, a width of a part of the second margin surface which is located on a more rear side in the rotation direction than the second straight line is larger than a width of a part of the second margin surface which is located on a more front side in the rotation direction than the second straight line.

5. The drill according to claim 1, wherein
the body comprises
a second flank surface that is flat and located along the second cutting edge,
a third flank surface which is located along the second flank surface on a rear side in the rotation direction, and which is inclined relative to the second flank surface, and
a fourth flank surface which is located along the third flank surface on a rear side in the rotation direction, and which is inclined relative to the third flank surface, and
the second margin surface connects to the third flank surface and is located away from the second flank surface and the fourth flank surface.

6. The drill according to claim 1, wherein the clearance surface comprises a plurality of ridge parts extended along the first margin surface.

7. The drill according to claim 1, wherein a width of the second margin surface in the rotation direction is equal to a length of the first cutting edge in the plan view of the first end.

8. A method for manufacturing a machined product, comprising:
rotating the drill according to claim 1;
bringing the drill being rotated into contact with a workpiece; and
moving the drill away from the workpiece.
